(19) United States
(12) Patent Application Publication
(10) Pub. No.: US 2005/0130019 A1
(43) Pub. Date: Jun. 16, 2005

(54) Structure for reducing internal circuit of fuel cell

(76) Inventors: Tae-Hee Cho, Gyeongsangnam-Do (KR); Myung-Seok Park, Gyeongsangnam-Do (KR); Hong Choi, Gyeongsangnam-Do (KR); Kyu-Jung Kim, Gyeonggi-Do (KR); Myeong-Ho Lee, Busan (FR); Cheol-Hwan Kim, Gyeongsangnam-Do (KR); Yong-Jun Hwang, Gyeongsangnam-Do (KR); Seung-Tae Ko, Daegu (KR); Seong-Geun Heo, Busan (KR)

Correspondence Address: FLESHNER & KIM, LLP, P.O. BOX 221200, CHANTILLY, VA, 20153, US

(21) Appl. No.: 10/485,287

(22) PCT Filed: Dec. 12, 2003
(86) PCT No.: PCT/KR03/02731

(51) Int. Cl. H01M 8/24

(52) U.S. Cl. 429/38; 429/18

(57) ABSTRACT

In a structure for reducing internal circuit of a fuel cell including adjacently stacked unit cells; a fuel side distributing means for connecting each fuel side inflow path of the unit cells and insulating them; and an air side distributing means for connecting each air side inflow path of the unit cells, electric connection among the stacked plural unit cells by fuel as an electrolyte solution and electric leakage by additional parts can be minimized.

### TECHNICAL FIELD

The present invention relates to a fuel cell, and in particular to an structure for reducing internal circuit of a fuel cell capable of minimizing an internal circuit occurred among plural stacked unit cells.

### BACKGROUND ART

Fuel cell has been presented as a substitute for fossil fuel, and it converts chemical energy generated by oxidation of fuel such as hydrogen into electric energy directly.

FIG. 1 illustrates an example of a fuel cell. As depicted in FIG. 1, in the fuel cell, when hydrogen-included fuel and air as a oxidant are supplied to a fuel electrode (anode) 11 and an air electrode (cathode) 12 arranged on both sides of an electrolyte layer 10 respectively, electrochemical oxidation reaction occurs on the fuel electrode 11, hydrogen ions and electrons are emitted, the hydrogen ions are moved to the air electrode 12 through the electrolyte layer 10, and the electrons are moved to the air electrode 12 through a load 20 connecting the fuel electrode 11 to the air electrode 12. Simultaneously electrochemical reduction reaction occurs on the air electrode 12, and heat and by-products are generated while the hydrogen ions are combined with oxygen. Herein, current is generated while the electrons emitted from the fuel electrode 11 are moved to the air electrode 12.

One unit fuel cell is constructed with the structure. Herein, in order to generate greater electric energy, a fuel cell can be constructed by combining plural unit cells.

In addition, fuel cells can be classified into various kinds according to kinds of fuel, operational temperature and catalyzers, etc.

When fuel of hydrogen group such as NaBH4, KBH4, LiA1H4, KH, NaH, etc. is dissolved in an alkali aqueous solution, the fuel becomes an electrolyte solution, electrons generated with hydrogen ions are moved through the electrolyte solution (fuel).

FIG. 2 is a sectional view illustrating an example of a fuel cell using the electrolyte solution as fuel in accordance with the conventional art, FIG. 3 is a plane view illustrating a stack of the fuel cell, FIG. 4 is a plane view illustrating a first manifold of the fuel cell, and FIG. 5 is a plane view illustrating a second manifold of the fuel cell.

As depicted in FIGS. 2˜5, in the fuel cell, monopolar plates 110, 120 are respectively arranged on both sides of one bipolar plate 100, two M.E.As (membrane electrode assembly) 130 are respectively inserted between the bipolar plate 100 and the monopolar plate 110, 120, and an end plate 140 is respectively arranged on both sides of the monopolar plates 110, 120. The bipolar plate 100, the monopolar plate 110, 120, the M.E.A 130 and the end plate 140 are fixedly combined by fastening means 150, and accordingly a stack is constructed.

In the bipolar plate 100, fluid flowing channels 102, 103 are respectively formed on both sides of a plate 101 having a certain thickness and area; and inflow paths 104, 105 and outflow paths 106, 107 in which fuel and air flow respectively are formed so as to be connected with the channels 102, 103.

In the monopolar plates 110, 120, fluid flowing channels 112, 122 are formed on a side of plates 111, 121 having a certain thickness and area; and inflow paths 113, 123 and outflow paths 114, 124 connected to the channels 112, 122 are formed on the plates 111, 121 so as to receive and discharge a fluid.

The fuel side inflow paths 104, 123 of the bipolar plate 100 and the monopolar plates 110, 120 are arranged on the same line, and the air side inflow paths 105, 113 are arranged on the same line with the fuel side inflow paths 104, 123 so as to have a certain interval.

In the M.E.A 130, a fuel side electrode 132 contacted to fuel is formed on a side of the electrolyte layer 131 having a certain area, and an air side electrode 133 contacted to air is formed on the other side of the electrolyte layer 131. In the M.E.As 130, the same electrode is arranged on the same position.

A first manifold 160 for distributing fuel and air so as to make them flow into the fuel side inflow paths 104, 123 and the air side inflow paths 105, 113 respectively is arranged on a side of the stack, a second manifold 170 for gathering fuel and air to be respectively discharged to the fuel side outflow paths 106, 124 and the air side outflow paths 107, 114 is arranged on the other side of the stack, and the first and second manifolds 160, 170 are fixedly combined by additional fastening means 180. In the first manifold 160, a fuel side space 162 and an air side space 163 are respectively formed in a body unit 162 having a certain thickness and rectangular area, through holes 164 connected with the fuel side inflow paths 104, 123 are formed on the bottom of the fuel side space 162, and through holes 165 connected with the air side inflow paths 105, 113 are formed on the bottom of the air side space 163. And, in the second manifold 170, a fuel side space 172 and an air side space 173 are respectively formed in a body unit 171 having a certain thickness and rectangular area, through holes 174 connected with the fuel side outflow paths 106, 124 are formed on the bottom of the fuel side space 172, and through holes 175 connected with the air side outflow paths 107, 114 are formed on the bottom of the air side space 173.

The fuel side space 162 of the first manifold is connected to a fuel tank (not shown) and a pump (not shown) by a pipe (not shown), and the fuel side space 172 of the second manifold is connected to the fuel tank by an additional reproducing means (not shown).

In the above-described fuel cell, when fuel in the fuel tank flows into the fuel side space 162 of the first manifold, simultaneously air flows into the air side space 163 of the first manifold. The fuel in the fuel side space 162 flows into the bipolar plate 100 and the inflow paths 104, 123 of the monopolar plate 120 of the stack through the through holes 164.

When the fuel flows in the channels 102, 122, electrochemical oxidation occurs on the fuel side electrode 132 of the M.E.A 130, hydrogen ions and electrons are generated, the hydrogen ions are moved to the air side electrode 133 through the electrolyte layer 131 of the M.E.A, and the electrons are moved to the air side electrode 133 through the bipolar plate 100 or the monopolar plates 110, 120. Simultaneously, when the air in the air side space 163 of the first manifold flows into the channels 103, 112 through the through holes 165 in the air side space, each bipolar plate 100 and the inflow paths 105, 113 of the monopolar plate 110 of the stack, electrochemical reduction reaction occurs with the hydrogen ions on the air side electrode 133 of the M.E.A.

In the meantime, the fuel discharged into the fuel side space 172 of the second manifold flows into the fuel tank through the reproducing means and is supplied again to the stack.

And, when a load is connected between the monopolar plates 110, 120, electric energy is generated while current flows through the load by electric potential difference.

However, in the conventional structure, because the electrolyte solution is used as fuel, the fuel connects the stacked unit cells electrically so as to construct an internal circuit, electric leakage may occur, and accordingly electrical loss may occur.

### TECHNICAL GIST OF THE PRESENT INVENTION

In order to solve the above-described problem, it is an object of the present invention to provide a structure for reducing internal circuit of a fuel cell capable of minimizing electric leakage occurred among plural stacked-unit cells.

In order to achieve the above-mentioned object, a structure for reducing internal circuit of a fuel cell includes adjacently stacked unit cells; a fuel side distributing means for connecting each fuel side inflow path of the unit cells and insulating them electrically; and an air side distributing means for connecting each air side inflow path of the unit cells.

In addition, a structure for reducing internal circuit of a fuel cell includes a stack consisting of adjacently stacked unit cells; a first and a second manifolds respectively arranged on both sides of the stack so as to have fuel side connection paths for connecting fuel side paths of the unit cells and air side connection paths for connecting air side paths of the unit cells; a first insulating member combined between the stack and the first manifold so as to have fuel side through holes for connecting the fuel side paths of the unit cell with the fuel side connection path of the first manifold and air side through holes for connecting the air side paths of the unit cell with the air side connection path of the first manifold; and a second insulating member combined between the stack and the second manifold so as to have fuel side through holes for connecting the fuel side paths of the unit cell with the fuel side connection path of the second manifold and air side through holes for connecting the air side paths of the unit cell with the air side connection path of the second manifold.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view illustrating a general fuel cell;

FIG. 2 is a sectional view illustrating an example of the conventional fuel cell;

FIG. 3 is a plane view illustrating a stack of a fuel cell in accordance with the conventional art;

FIGS. 4 and 5 are plane views respectively illustrating partial-exploded first and second manifolds of the fuel cell in accordance with the conventional art;

FIG. 6 is a sectional view illustrating a fuel cell having a structure for reducing internal circuit of a fuel cell in accordance with a first embodiment of the present invention;

FIG. 7 is a plane view illustrating the fuel cell in FIG. 6;

FIG. 8 is a sectional view illustrating a fuel cell having an internal circuit reducing structure in accordance with a second embodiment of the present invention;

FIG. 9 is a sectional view illustrating the fuel cell taken along a line A-B in FIG. 8;

FIG. 10 is a sectional view illustrating the fuel cell taken along a line C-D in FIG. 8; and

FIG. 11 is a graph showing comparison results of unit cells in accordance with the first and second embodiments of the present invention.

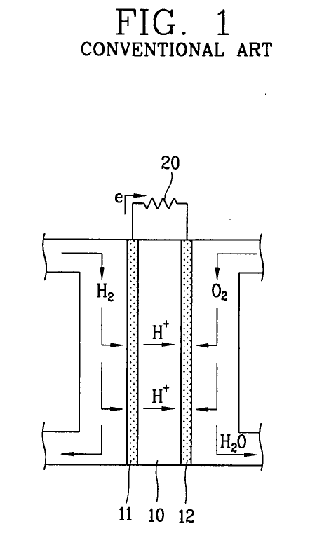

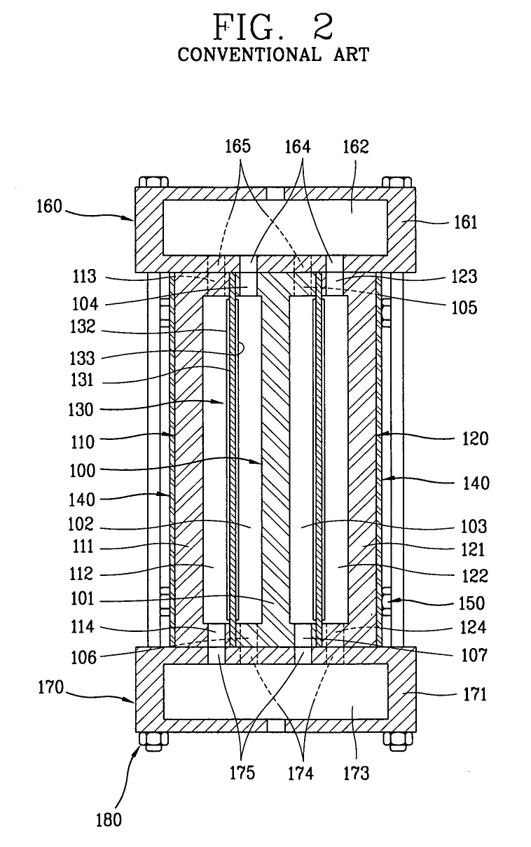

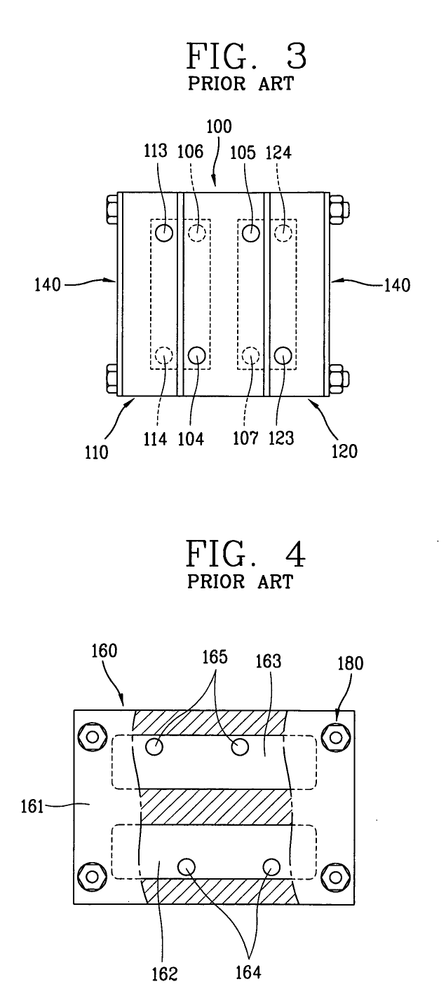

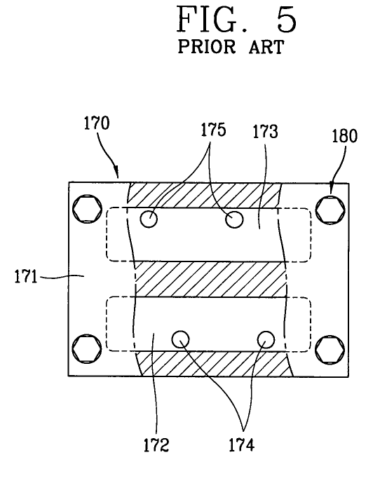

### DETAILED DESCRIPTION OF THE INVENTION

Hereinafter, the preferred embodiments of the present invention will be described with reference to accompanying drawings.

First, a structure for reducing internal circuit of a fuel cell in accordance with a first embodiment of the present invention will be described.

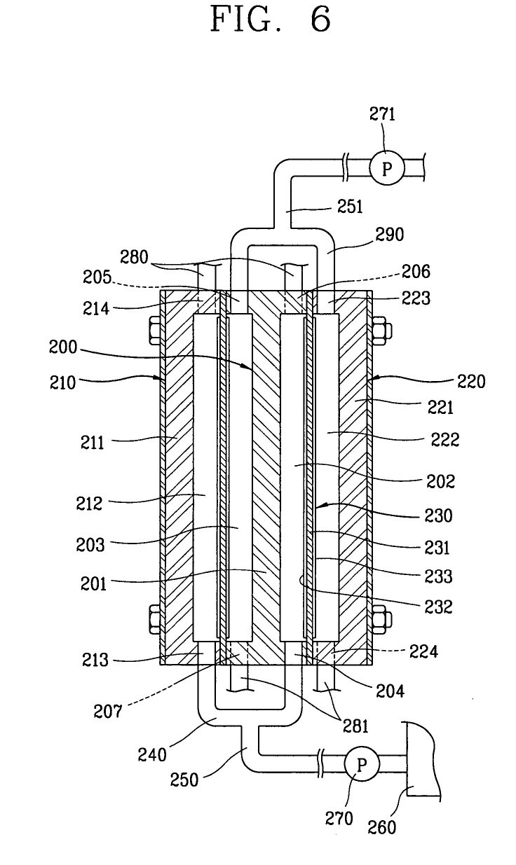

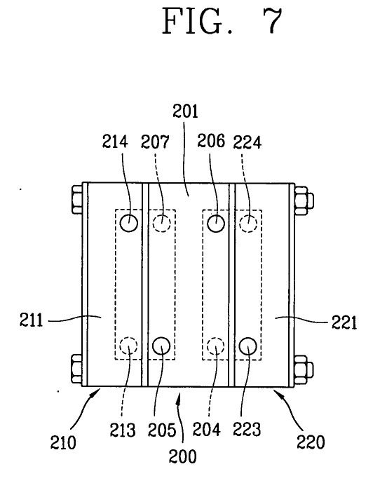

FIG. 6 is a sectional view illustrating a fuel cell having an internal circuit reducing structure in accordance with a first embodiment of the present invention, and FIG. 7 is a plane view illustrating the fuel cell in FIG. 6.

As depicted in FIGS. 6 and 7, the structure for reducing internal circuit of a fuel cell in accordance with the first embodiment of the present invention includes adjacently stacked unit cells (C); a fuel side distributing means for connecting each fuel side inflow path of the unit cells (C) and insulating them (electrically); and an air side distributing means for connecting each air side inflow path 205 of the unit cells (C).

The fuel side distributing means is a fuel side distributing pipe 240 for connecting each fuel side inflow path of the unit cells (C). The fuel side distributing pipe 240 distributes fuel to each fuel side inflow path of the unit cells (C) and simultaneously forms electrically insulating space.

The air side distributing means is an air side distributing pipe 280 for connecting each air side inflow path of the unit cells (C).

And, a fuel inflow pipe 250 is connected to the fuel side distributing pipe 240, and the fuel inflow pipe 250 is connected to a fuel tank 260. An air inflow pipe 290 in which external air flows is combined with the air side distributing means 280.

The unit cell (C) consists of a bipolar plate 200; monopolar plates 210, 220 respectively arranged on both sides of the bipolar plate 200; and a M.E.A 230 respectively inserted between the bipolar plate 200 and the monopolar plate 210, 220. The bipolar plate 200, the two monopolar plates 210, 220 and the M.E.A 230 construct one unit cell (C).

In the bipolar plate 200, channels 202, 203 are respectively formed on both sides of a plate 201 having a certain thickness and rectangular area, inflow paths 204, 205 for transmitting fuel and air respectively to the channels 202, 203 are formed on the plate 201, and outflow paths 206, 207 for discharging the fuel and air of the channels 202, 203 are formed on the plate 201. The fuel side inflow path 204 and the air side outflow path 207 are formed on a surface of the plate 201, and the fuel side outflow path 206 and the air side inflow path 205 are formed on another surface (opposed to the above-mentioned surface) of the plate 201. The fuel side inflow path 204 and the fuel side outflow path 206 are arranged diagonally, and the air side inflow path 205 and the air side outflow path 207 are arranged diagonally.

In the monopolar plate 210, 220, a channel 212, 222 is formed on a side of a surface 211, 221 having a certain thickness and rectangular area, and an inflow path 213, 223 and an outflow path 214, 224 for receiving and discharging a fluid into/from the channel 212, 222 are formed on the plate 211, 221. The monopolar plates 210, 220 are respectively arranged on both sides of the bipolar plate 200 so as to make the channels 212, 222 face the channels 202, 203 of the bipolar plate. Herein, when the channel 212 of the monopolar plate 210 faces the channel 203 in which air flows of the bipolar plate 200, fuel flows in the channel 212 of the monopolar plate 210. When the channel 222 of the monopolar plate 220 faces the channel 202 in which fuel flows of the bipolar plate 200, air flows in the channel 222 of the monopolar plate 220.

In the M.E.A 230, a fuel side electrode 232 on which fuel is contacted is formed on a side of an electrolyte layer 231 having a certain area, and an air side electrode 233 in which air is contacted is formed on the other side of the electrolyte layer 231. The M.E.A 230 is inserted between the bipolar plate 200 and the monopolar plate 210, 220 so as to make the electrodes 232, 233 be arranged in the same direction.

The fuel side distributing pipe 240 connects the fuel side inflow path 204 of the bipolar plate to the fuel side inflow path 213 of the monopolar plate in which fuel flows. The fuel side distributing pipe 240 is curved-formed. The fuel inflow pipe 250 is connected to the fuel side distributing pipe 240, and the fuel inflow pipe 250 is connected so as to be arranged on the center of the fuel side distributing pipe 240.

The fuel inflow pipe 250 is connected to a fuel tank 260 for storing fuel, a first pump 270 for pumping fuel is installed on the fuel inflow pipe 250, and the first pump 270 is arranged between the fuel side distributing pipe 240 and the fuel tank 260. Fuel of the fuel tank is an electrolyte solution.

The fuel side distributing pipe 240 and the fuel inflow pipe 250 are made of an insulating material.

An outflow pipe 208 is respectively combined with the fuel side outflow path 206 of the bipolar plate 200 and the fuel side outflow path 214 of the monopolar plate 210 adjacent to the fuel side outflow path 206 and having fuel.

The air side distributing pipe 290 connects the air side inflow path 205 of the bipolar plate 200 with the air side inflow path 223 of the monopolar plate 220 adjacent to the air side inflow path 205 and having air. The air side distributing pipe 290 is curved-formed. The air inflow pipe 251 is connected to the air side distributing pipe 290, and the air inflow pipe 251 is connected so as to be arranged on the center of the air side distributing pipe 290. The air side distributing pipe 290 and the air inflow pipe 251 are made of an insulating material.

A second pup 271 for pumping air is installed on the air inflow pipe 251.

An outflow pipe 281 is respectively connected with the air side outflow path 207 of the bipolar plate 200 and the air side outflow path 224 of the monopolar plate 220 adjacent to the air side outflow path 207 and having air.

The operation of the structure for reducing internal circuit of a fuel cell will be described.

First, when the first pump 270 and the second pump 271 are operated, fuel in the fuel tank 260 flows into the fuel side distributing pipe 240 through the fuel inflow pipe 250. The fuel in the fuel side distributing pipe 240 is distributed and flows into the fuel side inflow paths 204, 213 of each unit cell (C), the fuel in the fuel side inflow paths 204, 213 flows through the channels 202, 212. While the fuel flows through the channels 202, 212, electrochemical oxidation occurs by the fuel side electrode 232 of the M.E.A, hydrogen ions and electrons are generated, the hydrogen ions are moved to the air side electrode 233 through the electrolyte layer 231 of the M.E.A, and the electrons are moved to the air side electrode 233 through the bipolar plate 200.

Simultaneously, when external air flows into the air side distributing pipe 290 through the air inflow pipe 251 and flows into the air side inflow path 205, 223 of each unit cell (C). While the air in the air side inflow path 205, 223 of each unit cell (C) flows through the channels 203, 222, electron-chemical oxidation occurs on the air side electrode 233 of the M.E.A with the hydrogen ions.

The fuel passing the channel 202, 212 of each unit cell (C) is respectively discharged through the fuel side discharge path 206, 214 and the discharge pipe 280. The air passing the channel 203, 222 of each unit cell (C) is discharged through the air side outflow path 207, 224 and the outflow pipe 281. The fuel discharged through the outflow pipe 280 passes an additional reproducing means (not shown) and flows again into the fuel tank 260.

When a load is connected between the monopolar plates 210, 220, electric energy is generated while current flows through the load by the electric potential difference.

In that process, because the fuel supplied from the fuel tank 260 is distributed through the fuel side distributing pipe 240 and flows into the fuel side electrode 232 of each unit cell (C), electric leakage occurred by electric connection of the fuel can be restrained by the fuel side distributing pipe 240. In more detail, because the fuel as the electrolyte solution flowing into each unit cell (C) is connected through the fuel side distributing pipe 240 having a certain length, electric connection by the fuel is unstable, and accordingly electric leakage can be minimized.

In addition, the fuel passing each unit cell (C) is respectively discharged through an additional discharge pipe 280, electric connection by the fuel is cut off, and accordingly electric leakage can be prevented.

In the meantime, in the present invention, by installing respectively a pump 270, 271 for pumping fuel and air, the number of pumps can be minimized.

And, an internal ground current reducing structure of a fuel cell in accordance with a second embodiment of the present invention will be described.

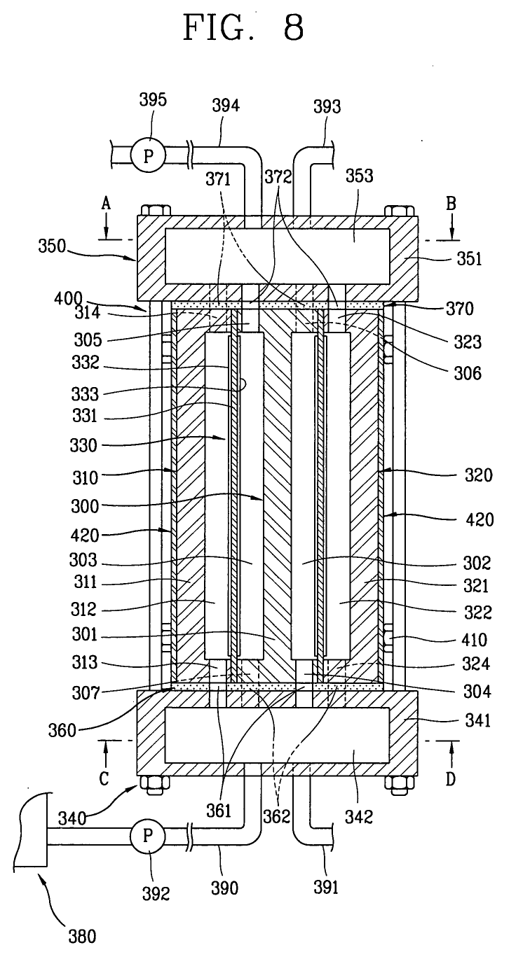

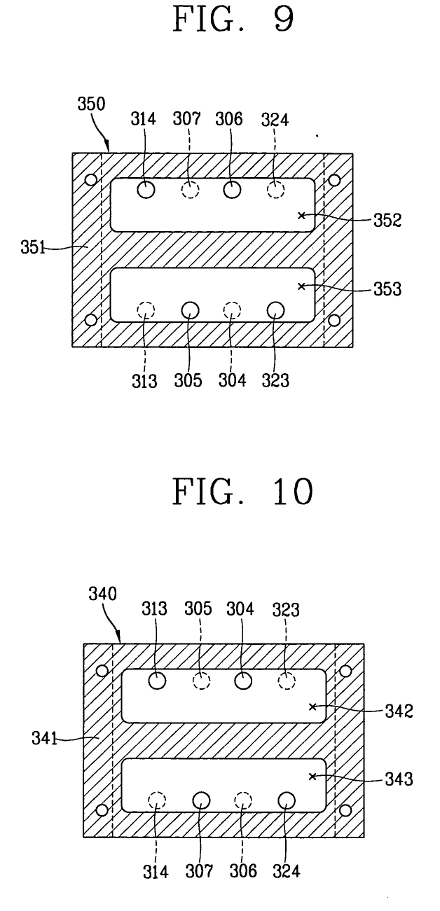

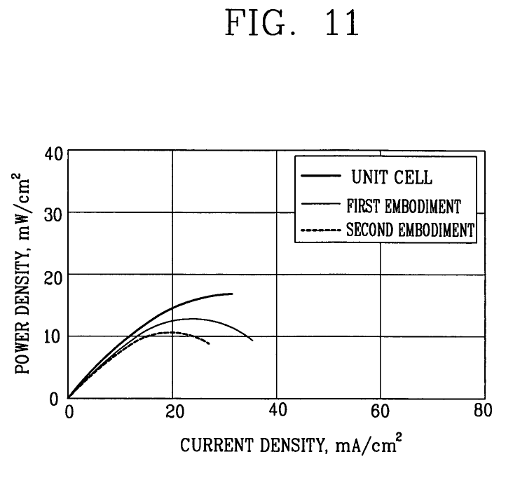

FIG. 8 is a sectional view illustrating a fuel cell having an internal circuit reducing structure in accordance with a second embodiment of the present invention, FIG. 9 is a sectional view illustrating the fuel cell taken along a line A-B in FIG. 8, and FIG. 10 is a sectional view illustrating the fuel cell taken along a line C-D in FIG. 8.

As depicted in FIGS. 8-10, the structure for reducing internal circuit of a fuel cell in accordance with the second embodiment of the present invention includes a stack consisting of stacked unit cells (C); a first and a second manifolds respectively arranged on both sides of the stack so as to have a fuel side connection path for connecting fuel side paths of the unit cells (C) and an air side connection path for connecting air side paths of the unit cells (C); a first insulating member combined between the stack and the first manifold so as to have fuel side through holes for connecting the fuel side paths of the unit cell (C) with the fuel side connection path of the first manifold and air side through holes for connecting the air side paths of the unit cell (C) with the air side connection path of the first manifold; and a second insulating member combined between the stack and the second manifold so as to have fuel side through holes for connecting the fuel side paths of the unit cell (C) with the fuel side connection path of the second manifold and air side through holes for connecting the air side paths of the unit cell (C) with the air side connection path of the second manifold.

The stack consists of two unit cells (C). In the unit cell (C), monopolar plates 310, 320 are respectively arranged on both sides of one bipolar plate 300, and a M.E.A 330 is respectively inserted between the bipolar plate 300 and the monopolar plate 310, 320.

The unit cell (C) consists of a bipolar plate, a monopolar plate and a M.E.A.

The bipolar plate 300, the monopolar plates 310, 320 and the M.E.A 330 have the same structure with the bipolar plate 200, the monopolar plates 210, 220 and the M.E.A 230 of the structure in accordance with the first embodiment.

Reference numerals 301, 311, 312 are plates, 302 and 303 are channels, 304 and 313 are fuel side inflow paths, 305 and 323 are air side inflow paths, 306 and 314 are fuel side outflow paths, 307 and 324 are air side outflow paths. In addition, reference numeral 331 is an electrolyte layer, 332 is a fuel side electrode, 333 is an air side electrode, and 420 is an end plate.

In the first manifold 340, a fuel side connection path 342 is formed on a side of a body 341 having a certain thickness and rectangular area, and an air side connection path 343 is formed on the other side of the body 341. The fuel side connection path 342 is formed so as to connect fuel side inflow paths 304, 313 of adjacent two unit cells (C). The air side connection path 343 is formed so as to connect air side outflow paths 307, 324 of the two unit cells (C).

In modification of the first manifold 340, it is divided into a part including the fuel side connection path 342 and a part including the air side connection path 343. The part including the fuel side connection path 342 and the part including the air side connection path 343 are formed so as to have a certain thickness and rectangular area.

In the second manifold 350, a fuel side connection path 352 is formed on a side of a body 351 having a certain thickness and rectangular area, and an air side connection path 353 is formed on the other side of the body 351. The fuel side connection path 352 is formed so as to connect fuel side outflow paths 306, 314 of adjacent two unit cells (C). The air side connection path 353 is formed so as to connect air side inflow paths 305, 323 of the two unit cells (C).

In modification of the second manifold 350, it is divided into a part including the fuel side connection path 352 and a part including the air side connection path 353. The part including the fuel side connection path 352 and the part including the air side connection path 353 are formed so as to have a certain thickness and rectangular area.

The first and second manifolds 340, 350 can be made of an insulating material, herein, usage of the first and second insulating members 360, 370 can be excluded.

The first and second manifolds 340, 350 are fixedly combined by additional fastening means 400.

The first and second insulating members 360, 370 have a rectangular shape and a certain thickness, and a fuel side through hole 361, 371 and an air side through hole 362, 372 are respectively formed in them. When the fuel side through hole 361, 371 and the air side through hole 362, 372 are filled with fuel, there is an insulating space.

A fuel inflow pipe 390 connected to the fuel tank 380 is connected with the fuel side connection path 342 of the first manifold 340, and an outflow pipe 391 for discharging air is connected with the air side connection path 343. A first pump 392 is installed on the fuel inflow pipe 390, and fuel stored in the fuel tank 380 is an electrolyte solution.

A fuel outflow pipe 393 for discharging fuel is connected with the fuel side connection path 352 of the second manifold 350, and an air inflow pipe 394 in which external air flows is connected with the air side connection path 353. A second pump 395 is installed on the air inflow pipe 394.

Hereinafter, the operation of the structure for reducing internal circuit of a fuel cell in accordance with the second embodiment of the present invention will be described.

First, fuel in the fuel tank 380 flows into the fuel side connection path 342 of the first manifold through the fuel inflow pipe 390 and flows into the fuel side inflow path 304, 313 of each unit cell (C) of the stack, and the fuel in the fuel side inflow path 304, 313 flows through the channels 302, 312. While the fuel flows through the channel 302, 312, electrochemical oxidation reaction occurs by the fuel side electrode 332 of the M.E.A, hydrogen ions and electrons are generated, the hydrogen ions are moved to the air side electrode 333 through the electrolyte layer 331 of the M.E.A, and the electrons are moved to the air side electrode 333 through the bipolar plate 300.

Simultaneously, when external air flows into the air side connection path 353 through the air inflow pipe 394 and flows into the air side inflow path 305, 323 of each unit cell (C). While the air in the air side inflow path 305, 323 of each unit cell (C) flows through the channel 303, 322, electron-chemical oxidation reaction occurs on the air side electrode 333 of the M.E.A with the hydrogen ions.

The fuel passing the channel 302, 312 of each unit cell (C) is respectively discharged through the fuel side discharge path 306, 314, the discharge pipe 393 and the fuel side connection path 352 of the second manifold. The air passing the channels 303, 322 of each unit cell (C) is discharged through the air side outflow paths 307, 324, the air side connection path 343 and the outflow pipe 391 of the first manifold. The fuel discharged through the outflow pipe 393 passes an additional reproducing means (not shown) and flows again into the fuel tank 380.

When a load is connected between the monopolar plates 310, 320, electric energy is generated while current flows through the load by the electric potential difference.

In that structure, because the first and second insulating members 360, 370 are combined between the first and second manifolds 340, 350, electric leakage performed by the stack, the first manifold 340, the stack and the second manifold 350 can be prevented.

In addition, by the first and second insulating members 360, 370, electric leakage occurred by connection of the fuel as the electrolyte can be minimized. In more detail, the electric connection of the fuel formed with the fuel side connection path 342 of the first manifold, the fuel side connection path 352 of the second manifold and the paths in which the fuel flows of the unit cells (C) is unstable by height of the fuel side through holes 361, 371 of the first and second insulating members 360, 370, and accordingly leakage can be minimized. In more detail, the fuel side through holes 361, 371 of the first and second insulating members perform functions of an insulating pipe, electric connection by the fuel is unstable, and leakage can be minimized.

In the meantime, when the first and second manifolds 340, 350 are made of an insulating material, electric connection by the fuel is unstable, and accordingly leakage can be minimized.

FIG. 11 is a graph showing comparison results of unit cells in accordance with the first and second embodiments of the present invention.

As depicted in FIG. 11, in the first and second embodiments, it can be known electric loss due to electric leakage is small in comparison with a general unit cell. The unit cell has a structure having little electric leakage caused by fuel and additional parts.

### INDUSTRIAL APPLICABILITY

As described-above, in the a structure for reducing internal circuit of a fuel cell in accordance with the present invention, among stacked plural unit cells, by minimizing electric connection by fuel as an electrolyte solution and electric leakage occurred by electric connection by additional parts, electric energy efficiency of a unit cell can be improved.

1. A structure for reducing internal circuit of a fuel cell, comprising:
adjacently stacked unit cells;
a fuel side distributing means for connecting each fuel side inflow path of the unit cells and insulating them electrically; and
an air side distributing means for connecting each air side inflow path of the unit cells.

2. The structure of claim 1, wherein the fuel side distributing means is a fuel side distributing pipe for connecting fuel side inflow paths of the unit cells and forming an insulating space, and the fuel side distributing pipe is made of an insulating material.

3. The structure of claim 1, wherein the fuel side inflow paths and the air side inflow paths are arranged so as to be opposite to each other.

4. The structure of claim 1, wherein a pump for supplying fuel is installed as the fuel side distributing means.

5. The structure of claim 1, wherein outflow pipes are respectively connected with fuel side outflow paths of the unit cells.

6. The structure of claim 1, wherein a pump for supplying air is installed as the air side distributing means.

7. A structure for reducing internal circuit of a fuel cell, comprising:
a stack consisting of adjacently stacked unit cells;
a first and a second manifolds respectively arranged on both sides of the stack so as to have fuel side connection paths for connecting fuel side paths of the unit cells and air side connection paths for connecting air side paths of the unit cells;
a first insulating member combined between the stack and the first manifold so as to have fuel side through holes for connecting the fuel side paths of the unit cell with the fuel side connection path of the first manifold and air side through holes for connecting the air side paths of the unit cell with the air side connection path of the first manifold; and
a second insulating member combined between the stack and the second manifold so as to have fuel side through holes for connecting the fuel side paths of the unit cell with the fuel side connection path of the second manifold and air side through holes for connecting the air side paths of the unit cell with the air side connection path of the second manifold.

8. The structure of claim 7, wherein the first and second insulating members respectively have a certain thickness so as to make internal through holes thereof have an insulating space.

9. The structure of claim 7, wherein the first and second manifolds are made of an insulating material.

10. The structure of claim 7, wherein the fuel side connection path of the first manifold is formed so as to connect fuel side inflow paths of adjacent two unit cells with each other, and the air side connection path of the first manifold is formed so as to connect air side outflow paths of the two unit cells with each other.

11. The structure of claim 7, wherein the first manifold is divided into a part including the fuel side connection path and a part including the air side connection path.

12. The structure of claim 7, wherein the fuel side connection path of the second manifold is formed so as to connect fuel side outflow paths of adjacent two unit cells with each other, and the air side connection path of the second manifold is formed so as to connect air side inflow paths of the two unit cells with each other.

13. The structure of claim 7, wherein the second manifold is divided into a part including the fuel side connection path and a part including the air side connection path.
